(19) United States
(12) Patent Application Publication
(10) Pub. No.: US 2017/0144754 A1
(43) Pub. Date: May 25, 2017

(54) SYSTEMS AND METHODS FOR POWERING AN AIRBORNE VEHICLE FROM A GROUND POWER SUPPLY

(71) Applicant: THE BOEING COMPANY, Chicago, IL (US)

(72) Inventors: Suhat LIMVORAPUN, Seal Beach, CA (US); Randy L. BRANDT, Huntington Beach, CA (US)

(21) Appl. No.: 14/952,581

(22) Filed: Nov. 25, 2015

(51) Int. Cl. B64C 39/02; B60L 9/00

(52) U.S. Cl. CPC B64C 39/022; B64C 39/024; B60L 9/00; B64C 2201/108; B64C 2201/042; B64C 2201/06; B60L 2210/10; B60L 2200/10; B60L 2200/36

(57) ABSTRACT

Systems and methods for powering an airborne transport vehicle from a ground power supply are provided. One system is a hovercraft power system having a ground power supply coupled with at least one on-board DC-DC power converter, wherein the on-board DC-DC power converter is positioned on-board a hovercraft. The hovercraft power system further includes a power cord tethered to the hovercraft, wherein the power cord is capable of delivering at least 100 kilowatts (kW) of power from the ground power supply to the hovercraft. The hovercraft power system also includes a tether dispenser configured to dispense or retract the power cord tethered to the hovercraft.

### BACKGROUND

The present disclosure relates in general to electric powered airborne vehicles, such as electric powered manned or unmanned rotorcrafts or hovercrafts.

Electric powered vehicles, such as electric powered unmanned rotorcrafts or hovercrafts have limited flight time due to on-board battery size and payload weight limitations. For example, a typical battery powered hovercraft like a quad-copter has a flying time of only 10 to 20 minutes fly time with conventional on-board battery power sources.

In order to extend the flight time to several hours, the vehicle primary power can be tethered from ground instead of supplied on-board the hovercraft or other airborne vehicle. However, when the hovercraft is used out in the field, a wall plug outlet is often hard or sometimes impossible to locate or access. As a result, conventional hovercraft, particularly for use in the field (e.g., outside of a building environment) typically use small and light weight hovercraft, which have limited payload capabilities, such as being limited to carrying or transporting light weight devices, for example, a small camera.

Some hovercraft are known that provide an on-board power system to convert high voltage down to low voltage for the motor controller and avionics. However, these systems are limited to applications requiring less than 2 kW of power. Moreover, known systems require complicated thermo-management arrangements, such as liquid heat pipes to dissipate heat generated from the DC-DC conversion process.

Thus, in conventional airborne vehicle devices, such as hovercraft, flight time with on-board battery supplies is very limited and systems having tethered arrangements do not provide sufficient power to carry heavier payloads and required complex systems, including cooling systems to operate, which add weight and cost to the overall system.

### SUMMARY

In one embodiment, a hovercraft power system is provided that includes a ground power supply coupled with at least one on-board DC-DC power converter, wherein the on-board DC-DC power converter is positioned on-board a hovercraft. The hovercraft power system further includes a power cord tethered to the hovercraft, wherein the power cord is capable of delivering at least 100 kilowatts (kW) of power from the ground power supply to the hovercraft. The hovercraft power system also includes a tether dispenser configured to dispense or retract the power cord tethered to the hovercraft.

In another embodiment, a hovercraft is provided that includes at least one propeller and at least one on-board DC-DC power converter configured to be coupled to a tethered power cord supplying power from a ground power supply to power the at least one propeller while the hovercraft is in flight and supporting a 20-100 pound or more payload.

In another embodiment, a method for powering a hovercraft is provided. The method includes mounting a power converter to the hovercraft and coupling the hovercraft to a tethered power supply. The method further includes powering the hovercraft while in flight with the tethered power supply such that at least a 20-100 pound or more payload is supported by the in-flight hovercraft.

### BRIEF DESCRIPTION OF THE DRAWINGS

FIG. 1 is a diagram illustrating a power supply in accordance with an embodiment.

FIG. 2 is a diagram illustrating a tethered power system arrangement in accordance with an embodiment.

FIG. 3 is a diagram illustrating a tethered power system arrangement in accordance with another embodiment.

FIG. 4 is a schematic diagram illustrating a DC-DC converter in accordance with an embodiment.

FIG. 5 is a diagram illustrating an on-board DC-DC converter in accordance with an embodiment.

FIG. 6 is a diagram illustrating an on-board power system in accordance with an embodiment.

FIG. 7 is a block diagram of an airborne vehicle production and service methodology.

FIG. 8 is a block diagram of a method for powering a hovercraft in accordance with an embodiment

### DETAILED DESCRIPTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry, between software elements or between hardware and software implementations. Thus, for example, one or more of the functional blocks may be implemented in a single piece of hardware or multiple pieces of hardware. Similarly, the software programs may be stand-alone programs, may be incorporated as subroutines in an operating system, and the like. It should be understood that the various embodiments are not limited to the arrangements and instrumentality shown in the drawings.

As used herein, the terms “system,” “subsystem”, “unit,” or “module” may include any combination of hardware and/or software system that operates to perform one or more functions. For example, a system, unit, or module may include a computer processor, controller, or other logic-based device that performs operations based on instructions stored on a tangible and non-transitory computer readable storage medium, such as a computer memory. Alternatively, a system, subsystem, unit, or module may include a hard-wired device that performs operations based on hard-wired logic of the device. The systems, subsystems, modules, or units shown in the attached figures may represent the hardware that operates based on software or hardwired instructions, the software that directs hardware to perform the operations, or a combination thereof.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide a power system for airborne, vehicles devices or flying crafts, such as rotorcrafts or hovercrafts. Although described in connection with a hovercraft application, the various embodiments described herein are operational with numerous other general purpose or special purpose cargo transportation applications, environments, and/or other configurations. Examples of cargo transportation applications, environments, and/or configurations that may be suitable for use with aspects of the disclosure include, but are not limited to, humanitarian applications, the logging industry, the train industry, the aircraft industry and/or the ship industry.

Additionally, while the term “vehicle” is described hereinafter as a hovercraft, rotorcraft or other airborne vehicle, the various embodiments and advantageous effects may be provided with different devices and in different applications, for example, not in conjunction with the delivery of cargo or supply parts.

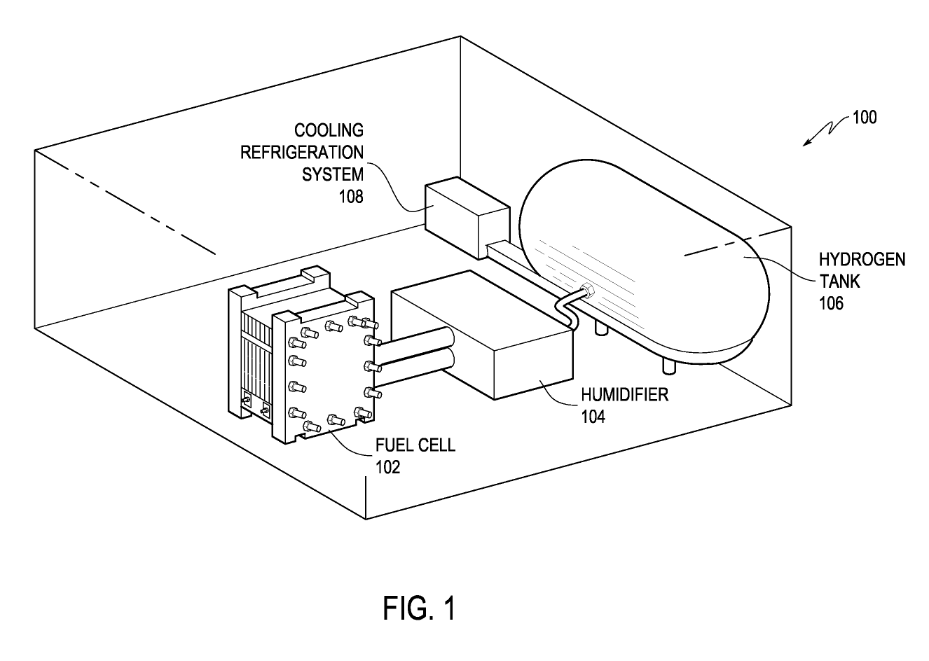

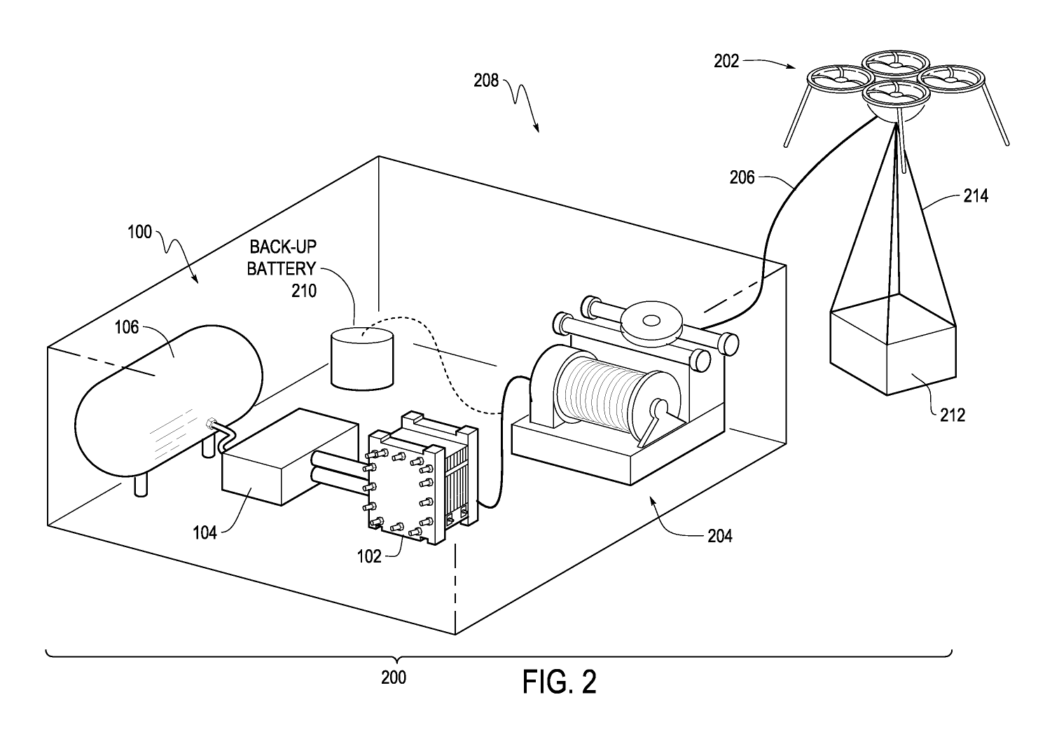

A power system in accordance with one or more embodiments is a tethered power system as shown in FIGS. 1 and 2, which employs fuel cell technology coupled with an on-board DC-DC power converter to provide a high power solution for tethered powered airborne devices, such as a tethered electric powered hovercraft. The tethered power system in accordance with various embodiments is capable of generating very high power for large manned or unmanned hovercraft. For example, one or more embodiments of a tethered power system can provide power up to several 100 kW to power a large hovercraft carrying a heavy payload (e.g., more than 20 pounds and up to or more than 100 pounds). In some embodiments, the tethered power system is used to provide a power source or supply to a hovercraft for transporting cargo from a parking lot to roof top of a building, manned/unmanned search and rescue from a building and/or disaster relief support, among other uses and applications.

For example, a power supply 100 may be used to power a hovercraft 202 (illustrated as a multi-rotor hovercraft) as part of a tethered power system 200. As will be appreciated from the present disclosure, the power supply 100 in accordance with various embodiments provides a portable, reliable and high power ground generator using fuel cell technology, which may be implemented for large hovercraft applications. For example, in some embodiments, the power supply 100 is a ground-based power generator to produce high voltage up to 1000 VDC having up to several hundred kW of power output. In operation, the power supply 100 is connected to a tether dispenser 204 that in the illustrated embodiment includes small AWG tether power cord wires. For example, in one embodiment, a tether power cord 206 with a length of 500 feet to 1000 feet is attached to the hovercraft 202. However, as should be appreciated, other lengths of power cord may be used as desired or needed. Additionally, the power supply 100 and tether dispenser 204 may be movably mounted to a ground location or mounted to a movable transport vehicle (e.g., a truck).

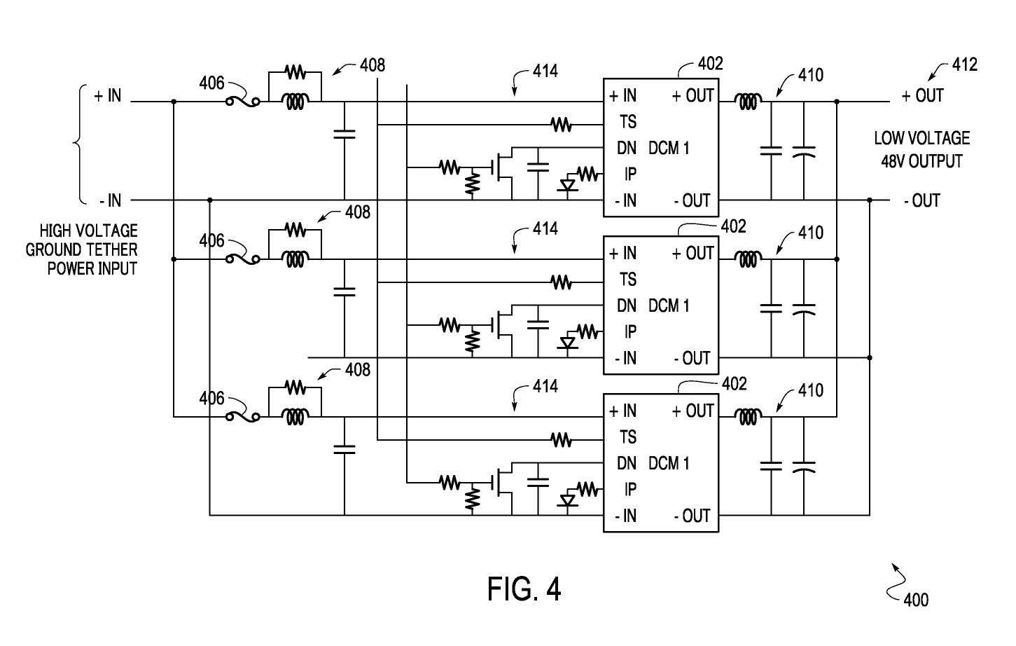

In operation, the hovercraft 202 includes one or more power conversion systems, such as on-board DC-DC converters that convert the tether high voltage down to a usable voltage for a motor controller, such as 50 VDC. In some embodiments, the on-board DC-DC converters 400 (shown in FIG. 4) are efficient, compact, lightweight and powerful. For example, for a vehicle weight of 150-200 pounds, the power to keep the hovercraft 202 aloft is about 15-27 kW. Using high voltage with the tether power cord 204 allows for smaller tether AWG wire size, which allows for a reduction in the tether cord weight. As disclosed herein, the tether power cord 204 is also able to carry a hundred kW of power or more.

The power supply 100 in some embodiments generates high voltage and high power using fuel cell technology. For example, in one or more embodiments, the power supply 100 is a 100 kW fuel cell stack, which in some embodiments may be implemented similar to a fuel cell used in automotive applications. In operation, the power supply 100 operates with zero CO₂ emission with the only by product from the fuel cell stack being heat and water. Moreover, because in various embodiments, there is no engine operation, quiet operation can be provided during power generation. It should be noted that in applications where quiet operation is not desired or needed, a diesel generator may be used. It also should be noted that the power source from the fuel stack may be used for other loads when the hovercraft 202 is not in use.

As described in more detail herein, the high efficiency DC-DC converter embodied as the DC-DC converter 400 eliminates the need for complex thermo-design management. For example, in some embodiments, only a heat sink in combination or communication with the DC-DC converter 400 is used.

Referring now to FIGS. 1-4, the tethered power system 200 may form part of a high power hovercraft system 208 for powering the hovercraft 202 for extended periods of time (e.g., more than thirty minutes) and carrying heavier payloads (e.g., payloads of 100 pounds or more in some embodiments). The high power hovercraft system 208 includes a ground power supply illustrated as the power supply 100 (which may employ fuel cell technology in some embodiments) coupled with at least one on-board DC-DC power converter 400 (which may be embodied as one or more power converter modules) and a heat sink in communication with the DC-DC converter 400 as described in more detail herein. It should be noted that in some embodiments, the high power hovercraft system 208 provides power to the hovercraft 202 that allows for carrying payloads in the range of 20-100 pounds (or more is some embodiments). However, the various embodiments are not limited to powering the hovercraft 202 to carry a payload of 20-100 pounds, but smaller or larger payloads may be supported, for example, a payload of one pound or less, 1-5 pounds, 10-20 pounds or payloads that are heavier than 100 pounds, such as 150 pounds, 200 pounds or more. In the various embodiments, the high power hovercraft system 208 may be modified as desired or needed to increase or decrease the power supply capability of the power supply 100, for example, by adding additional fuel cells or layers in the fuel stack.

The tether power cord 204, which may be a light weight power cord, is tethered to the hovercraft 202, wherein the tether power cord 204 is capable of delivering a minimum of 100 kW of power in some embodiments. The mobility of the hovercraft 202 relative to the power supply 100 is provided in some embodiments with a tether dispenser 204 (e.g., a tether power cord 204 reel), wherein the dispenser reel of the tether power cord 204 automatically retracts or dispenses the tether power cord 204, which may be at a preselected tension. It should be noted that in some embodiments, the high power hovercraft system 208 may further include a battery back-up supply 210.

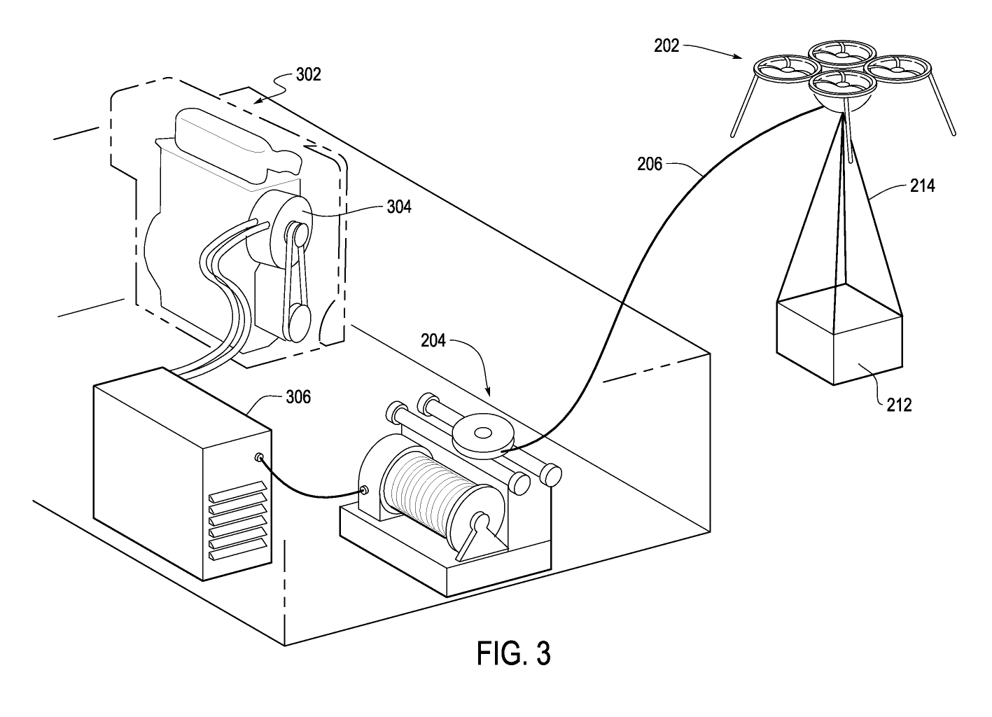

The high power hovercraft system 208 in various embodiments allows for generating up to several hundreds of kW of power for the hovercraft 202 using fuel cells technology as shown in FIGS. 1 and 2. In other embodiments, for example as shown in FIG. 3, a high power hovercraft system 300 may be provided that allows for generating up to several hundreds of kW of power using a diesel engine and advanced PFC rectification as described herein. Thus, in operation of the embodiments described herein, a large amount of power may be delivered from a high voltage ground DC power supply to a floating platform. In some of the embodiments, a very high efficiency on-board converter is used to convert high voltage to low voltage for a motor controller as described herein.

As can be seen in FIG. 1, the power supply 100 includes a fuel cell stack 102 (also referred to as the fuel cell 102) that uses hydrogen as the fuel source. In operation, the by product is water vapor that can be reclaimed by a humidifier 104 at an air intake. It should be appreciated that the fuel cell layers can be stacked in different configurations and arrangements using different fuel cell technology methods to generate the desired output voltage needed. For example, for a 400 V output, in one embodiment, 400 layers of fuel cell stacks 106 are used. The area size of each cell stack layer is determined based on the amount of power per cell. In one embodiment, for a 100 kW fuel cell stack, the dimensions for a 400 V output are approximately 18 inches×11 inches×18 inches. Additionally, in some embodiments, the weight for the dry cells is around 800 pounds.

In operation, the fuel cell 102 is hydrated with water vapor for operation using one or more fuel cell hydration methods. If the fuel cell 102 is too dry, the output power output will drop noticeably. Additionally, if the membrane gets too dry, localized overheating and cracking can damage the cells membrane. In accordance with some embodiments, the O₂ air breathing inlet flow is pre-conditioned with the humidifier 104, which is coupled between the fuel cell 102 and a hydrogen tank 106. The hydrogen tank 106 in various embodiments can store compressed gas or liquid hydrogen. It should be noted that if liquid hydrogen is used, the hydrogen tank 106 is insulated using one or more hydrogen tank insulation methods.

In various embodiments, a cooling refrigeration system 108 is used to keep the hydrogen tank 106 below a predetermined temperature, for example, below 253 degrees Celsius to maintain the state of the hydrogen liquid. In one embodiment, the hydrogen tank 106 is a 130 liter liquid tank does not have to support high pressure compared to compressed gas. If the liquid tank pressure is greater than 100 psi, a tank pressure relive valve (not shown) will open to allow hydrogen to be safely released in small quantities. It should be noted that without refrigeration, the insulated hydrogen will be empty from hydrogen tank 106 over an approximately 10 day period. If compressed hydrogen gas is used, the hydrogen tank 106 is designed to support 10,000 psi by using carbon fiber reinforced tanks. It should be noted that depending on safety requirements, two or three smaller high pressure tanks can be strapped together in parallel instead of using a single tank. The pressure when using multiple tanks may be reduced to a typical 100-200 psi needed by the fuel cell 102.

As shown in FIG. 2, the power supply 200 may be incorporated as part of the high power hovercraft system 208 to allow for providing a fuel cell ground supply system having the cell stack 102 that supplies high voltage, such as a minimum of 100 kW of power in some embodiments to the hovercraft 202 using the tether power cord 206 dispensed by the tether dispenser 204. For example, in one embodiment, the tether dispenser 204 is capable of dispensing up to 1000 feet of small high voltage 16 AWG wires as the tether power cord 206. The tether dispenser 204 automatically unwinds and rewinds the tether power cord 206, for example, using a tensioned arrangement that keeps a sufficient or required tension on the tether power cord 206. It should be noted that in some embodiments, in addition to the tether power cord 206, the tether cord can include one or more data lines to allow ground communication with an on-board flight control system of the hovercraft 202.

The end of the tether power cord 206 that extends from the tether dispenser 204 is attached to the hovercraft 202 carrying a heavy load 212 (e.g., 100 pounds or more) supported from the hovercraft 202, such as with suitable support cables 214 arranged to balance the load 212 under the hovercraft 202. It should be noted that although the hovercraft 202 is illustrated as a quad-hovercraft having four propellers, different types of hovercrafts or airborne vehicles may be powered using the disclosed embodiments.

In some embodiments, the ground power supply may be modified. For example, as shown in FIG. 3, a diesel engine 302 is used to supply the power to the hovercraft 202. It should be noted that like numerals represent like parts throughout the figures.

In the embodiment illustrated in FIG. 3, the diesel engine 302 (e.g., a shaft of the engine) is attached to an alternator 304 (or generator). In one embodiment, the alternator 304 is configured for multiphase operation, for example 3Y phase operation at 400 Hz. The winding outputs from the alternator 304 are connected to a rectification and filter system 306. Because the outputs of the alternator 304 have inductive windings with reactive components, it is desirable to minimize the reactive component using some form of power factor corrective. In one embodiment, a transformer rectifier assembly (TRA) is embodied as the rectification and filter system 306 to make the reactive component behave more like a resistive power source.

FIG. 4 illustrates a DC-DC converter 400 in accordance with one embodiment. In the illustrated embodiment, plural converter modules 402 are connected in parallel to convert the DC power received by the hovercraft 202 from the tether power cord 206. For example, in one embodiment, the converter modules 402 may be BCM converter modules (available from Vicor Corporation) that convert high voltage 500 VDC to low voltage 48 V. However, as should be appreciated, different types of DC-DC converters may be used and may convert between different voltages. Additionally, the number of converter modules 402 used may be varied based on, for example, the input and output power requirements.

In the DC-DC converter 400, an input terminal 404 receives high voltage power from through the tether power cord 206 that is input in parallel through a plurality of fuses 406 and input filters 408 (illustrated as RLC circuits). The filtered input power supply is provided to the converter modules 402 connected to the input filters 408 (before down-conversion of the high voltage). The outputs of the converter modules 402 are connected to output filters 410 (illustrated as LC circuits). In the illustrated embodiment, the 48 V low side filter outputs are connected together at a low voltage output terminal 412 to produce a high current power output. In some embodiments, the output filters 410 are configured to reduce switching noise from the converter modules 402 and/or noise generated by the motor within the hovercraft 202 that powers the hovercraft 202 as described in herein.

The DC-DC converter 400 also includes switching circuits 414 that enable switchable operation of the converter modules 402. For example, the switching circuits 414 in some embodiments are configured to turn on and off the converter modules 402, such as at certain times when it is not desirable for the hovercraft 202 to be operating.

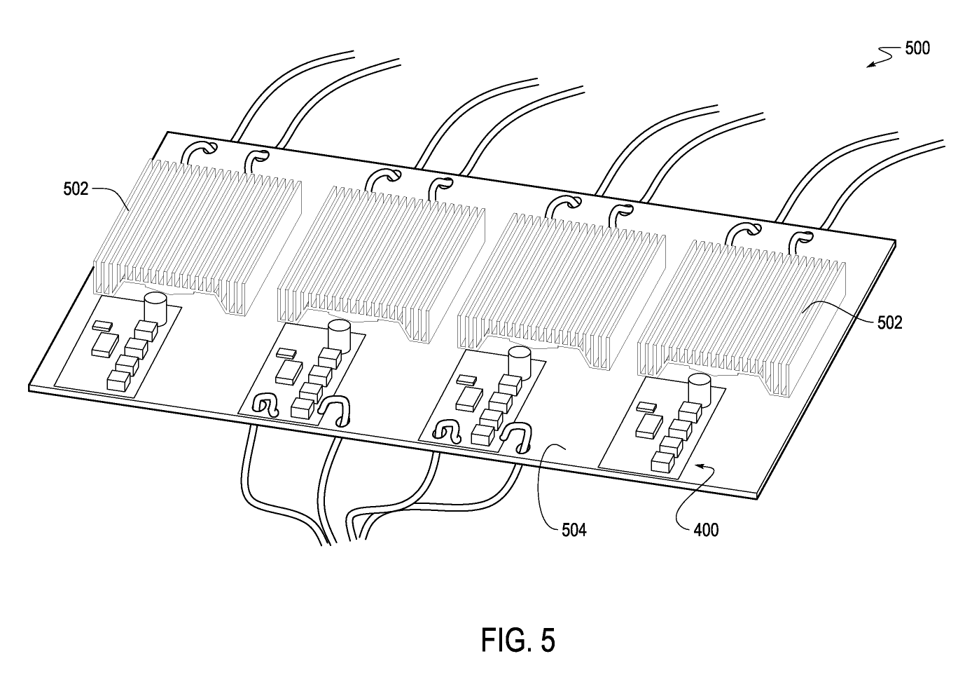

FIG. 5 illustrates an on-board DC-DC converter 500 in accordance with one embodiment. The on-board DC-DC converter 500 includes DC-DC converters 400 each having a heat sink 502 positioned adjacent thereto. For example, the heat sinks 502 may be plate or fin type heat sinks coupled adjacent to the DC-DC converters 400 on a printed-circuit board (PCB) 504. In one embodiment, the on-board DC-DC converter 500 is a BCM 6.8 kW converter board (available from Vicor Corporation) with adjacently coupled heat sinks 502. In the illustrated embodiment, the on-board DC-DC converter 500 has dimensions of 10 inches×5.5 inches×1 inch, with a weight of 1.5 pounds.

Using the on-board DC-DC converter 500, which may be coupled to the hovercraft 202, the hovercraft 202 can be powered for long term continuous flying operation while carrying a heavy load. For example, in one embodiment, the on-board DC-DC converter 500 is used in connection with a hovercraft 202 having a Quad Copter 9 horsepower (hp) motor. In one embodiment, for four motors on the hovercraft 202 (configured as a large Quad Copter), one on-board DC-DC converter 500 per motor provides up to 27 kW of power for the motors at 98% efficiency.

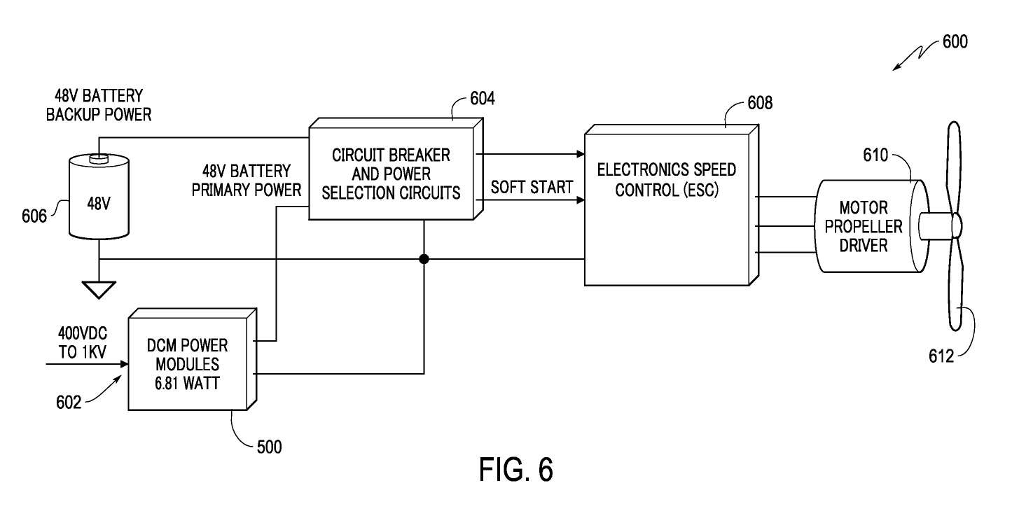

FIG. 6 illustrates an on-board power system 600 that may form part of the hovercraft 202. The on-board power system 600 receives high voltage power from the tether power cord 206 to provide propulsion of the hovercraft 202, which may be configured as a quad copter. In the illustrated embodiment, the high voltage power is received at an input for the on-board DC-DC converter 500 from the tether power cord 206. In various embodiments, plural on-board DC-DC converters 500 are provided, which can provide desirable redundancies.

The on-board DC-DC converter 500 converts the high voltage power to low voltage power, such as 48 VDC. The output of the on-board DC-DC converter 500 is connected to a power selection circuit 604 (that may include a circuit breaker). The power selection circuit 604 is configured to allow a multiplexed output between power from the tether power cord 206 and a back-up battery source 606, also connected to the power selection circuit 604. Thus, the power from the on-board DC-DC converter 500 defines a primary power source and the power from the back-up battery source 606 defines a back-up power source. The power selection circuit 604 provides seamless transfer of power from the on-board DC-DC converter 500 to the back-up battery source 606, for example, if there is a power failure or power issue from the tether power cord 206 or intermittent power from the tether power cord 206. It should be noted that the back-up battery source 606 is pre-charged prior to flight of the hovercraft 202, but may be charged while in flight.

The output of the power selection circuit 604 is connected to an electronics speed controller (ESC) 608 that controls the power to a motor propeller driver 610 that drives a propeller 612 of the hovercraft 202. For example, in one embodiment, the power selection circuit 604 is configured to output three-phase power to the motor propeller driver 610, which may be the drive motor that causes rotation of the propeller 612.

In various embodiments, the on-board DC-DC converters 500 are positioned within the hovercraft 202 such that airflow from the propellers 612 cools the on-board DC-DC converters 500. For example, the on-board DC-DC converters 500 may be positioned adjacent to the one or more of the motor propeller drivers 610. As a result, large heat sinks, such as heat pipes are not needed.

Thus, various embodiments provide tethered power to a hovercraft that allows for longer duration flights and carrying heavier payloads. In some embodiments, at least 100 kW of power or more is generated at a high voltage (e.g., 1000 VDC) and converted to useful power for a hovercraft (e.g., 48-50 VDC). Thus, unlike conventional hovercraft systems, various embodiments allow for operation of larger hovercrafts that carry heavier loads (e.g., loads of several hundreds of pounds). The extra payload weight carrying capabilities also allows support of wider applications.

The on-board DC-DC converters 500 also provide increased efficiency in voltage compared to conventional systems. For example, in some embodiments, more than 98% of switching losses may be eliminated.

Moreover, unlike conventional hovercraft power systems, various embodiments utilize fuel cell technology as the power generator source for the hovercraft. Additionally, various embodiments provide a smaller DC-DC power converter board with improved SWAP (size, weight, and power).

The DC-DC power converters in some embodiments utilize sine amplitude converters that have a very high power density (2735 W/in³). Additionally, the weight of each 1.2 kW DC-DC power converter is about 41 grams with a low voltage power output for each converter module being up to 1750 watt.

The efficiency for the converter modules is up to 98%, which minimizes the need for elaborate or complex thermo-management. The DC-DC converter modules can also be operated in parallel to multiply the power output capability, thereby meeting large hovercraft power demand.

In operation, a hovercraft powered by one or more embodiments can carry large and heavy payloads and allows the hovercraft to be flown for hours at a time (e.g., as long as the ground powered fuel lasts). Moreover, the fuel tank can be refueled as fast as filling up gas in the car and the entire ground power arrangement can be supported and moved around on the ground in a vehicle with no other supporting hardware needed.

Thus, one or more embodiments can generate high voltage and high power using fuel cell technology. In one or more embodiments, the following may be provided:

1. Each fuel cell layer having typically 0.6 V to 1.2 V depending on hovercraft load.

2. For a 400 V output, a fuel cell has about 400 fuel cell stack layers.

3. The 100 kW fuel cell stack can be similar to a fuel cell used in an automotive application.

4. The only by product from the fuel cell stack is heat and water, with zero CO₂ emission.

5. The fuel cell has quiet operation, with no engine running noise during power generation.

6. The powerful power source from the fuel stack can be used for other loads when the hovercraft is not in use.

7. The hydrogen fuel tank may be a Hydrogen Fuel Tank Type IV carbon fiber and polymer reinforced 130 liter tank (700 bar or 10,000 psi); 4-kilogram hydrogen tank (8.8 pounds), wherein 1 kg=2.2 lbs=14.1 liter.

8. The fuel cell stack operating pressure is 16 bar or 232 psi max.

9. The fuel cell stack has an Open Cathode Air breathing design, with no O₂ tank needed.

10. The dimensions are 18.2 inches×11 inches×18.3 inches for a 132 kW stack of 400 cells.

11. A 100 kW fuel cell stack has a dry weight of about 800 pounds.

12. A fuel stack operating temperature of −40 degrees Celsius to 60 degrees Celsius, with environment controlled with a fan and humidifier.

13. The cost of hydrogen is comparable to diesel fuel (in large quantities).

Variations and modifications are contemplated by the present disclosure. For example, as described herein, a diesel engine can be used to turn the generator shaft. In some embodiments, the following is provided:

1. A diesel engine that operates at 3000 rpm and can generate up to 100 kW of power.

2. A 2.5 liter engine having 3 cylinders can generate 40 kW of power and weighs about 800 pounds.

3. An alternator connected to the diesel shaft can have multi-phase output windings providing high voltage power.

4. An alternator rectification technique may be used to reduce the reactive component making output more resistive.

5. An advanced alternator design supports multi-phase windings output at 400 Hz.

6. A generator supporting diesel speed variation drops of 5% to 10% at 3000 rpm.

As described herein, the on-board hovercraft DC-DC power converter provides power to motor controllers. For example, in some embodiments, the following is provided:

1. An on-board DC-DC converter that converts high voltage input 500 VDC or 1 k VDC to 50 VDC output.

2. A DC-DC converter having very high efficiency of 98%

3. A high efficiency DC-DC converter that eliminates the need for complex thermo-design management.

4. Only heat sinks on the DC-DC converter modules are needed for cooling.

5. A small envelope board size of 10 inches×5.5 inches×1 inch with a 6.8 kW total power output.

6. Each DC-DC 6.8 kW converter board weighs 1.5 pounds.

7. The DC-DC converter modules can be parallel and share current evenly (<3% difference).

8. Each DC-DC converter board can supply 6.8 kW of power, so for a Quad Copter, the total vehicle power is approximately 27 kW.

9. Use of off-the-shelf power converter for the hovercraft application.

10. For vehicle safety, include redundant battery backup support in case a loss of tether power is encountered.

The various embodiments may be implemented in connection with different computing systems. Thus, while a particular computing or operating environment may be described herein, the computing or operating environment is intended to illustrate operations or processes that may be implemented, performed, and/or applied to a variety of different computing or operating environments.

The disclosure and drawing figure(s) describing the operations of the method(s) set forth herein should not be interpreted as necessarily determining a sequence in which the operations are to be performed. Rather, although one illustrative order is indicated, it is to be understood that the sequence of the operations may be modified when appropriate. Accordingly, certain operations may be performed in a different order or simultaneously. Additionally, in some aspects of the disclosure, not all operations described herein need be performed.

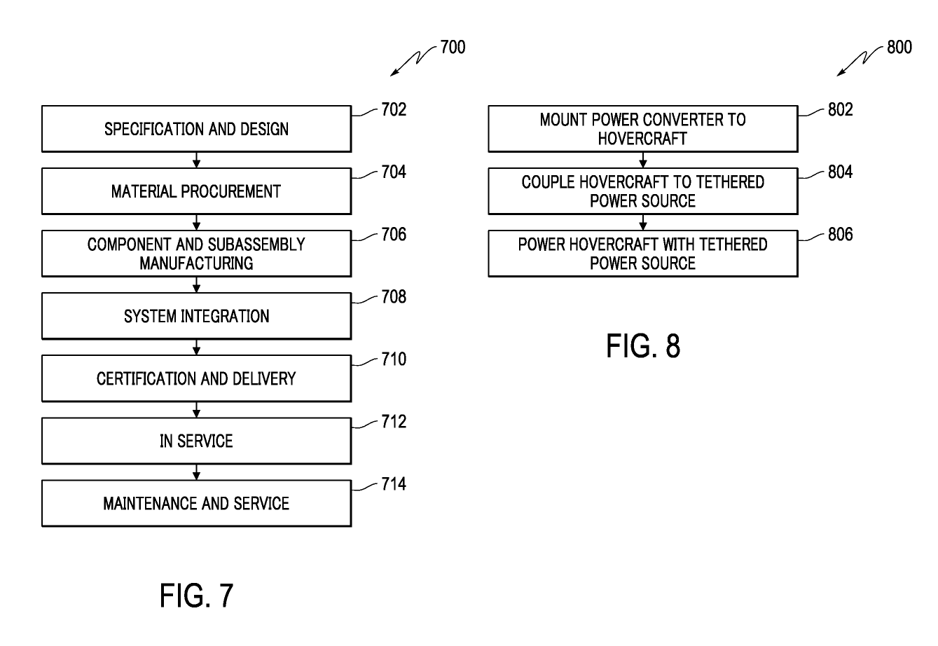

Examples of the disclosure may be described in the context of an airborne vehicle manufacturing and service method 700 as shown in FIG. 7 and an airborne vehicle, such as the hovercraft 202 (shown in FIG. 2). During pre-production, the illustrative method 700 may include specification and design 702 of the airborne vehicle and material procurement 704. During production, component and subassembly manufacturing 706 and system integration 708 of the airborne vehicle take place. Thereafter, the airborne vehicle may go through certification and delivery 710 to be placed in service 712. While in service by a customer, the airborne vehicle is scheduled for routine maintenance and service 714 (which may also include modification, reconfiguration, refurbishment, and so on).

Each of the processes of the illustrative method 700 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Apparatus and methods shown or described herein may be employed during any one or more of the stages of the manufacturing and service method 700. For example, components or subassemblies corresponding to component and subassembly manufacturing 706 may be fabricated or manufactured in a manner similar to components or subassemblies produced while the airborne vehicle is in service. Also, one or more aspects of the apparatus, method, or combination thereof may be utilized during the production states 706 and 708, for example, by substantially expediting assembly of or reducing the cost of the airborne vehicle. Similarly, one or more aspects of the apparatus or method realizations, or a combination thereof, may be utilized, for example and without limitation, while the airborne vehicle is in service, e.g., maintenance and service 714.

A method 800 for powering an airborne vehicle, such as a hovercraft, is shown in FIG. 8. The method includes mounting a power converter to the hovercraft at 802. For example, the on-board DC-DC converter 500 may be coupled with the hovercraft 202. As described herein, the on-board DC-DC converter 500 is mounted in proximity to one or more propellers of the hovercraft, such that airflow from the one or more propellers cools the on-board DC-DC converter 500.

The method 800 also includes coupling the hovercraft 202 to a tethered power source, such as a ground power source (e.g., the power supply 100) at 804. The hovercraft 202 is coupled to the ground power source while in flight and powered at 806 to allow for supporting or transporting a heavy load, such as a load of 20 pounds, 50 pounds, 100 pounds or more.

Different examples and aspects of the apparatus and methods are disclosed herein that include a variety of components, features, and functionality. It should be understood that the various examples and aspects of the apparatus and methods disclosed herein may include any of the components, features, and functionality of any of the other examples and aspects of the apparatus and methods disclosed herein in any combination, and all of such possibilities are intended to be within the spirit and scope of the present disclosure.

It should be noted that the various embodiments may be implemented in hardware, software or a combination thereof. The various embodiments and/or components, for example, the modules, or components and controllers therein, also may be implemented as part of one or more computers or processors or field-programmable gate arrays (FPGAs). The computer or processor or FPGA may include a computing device, an input device, a display unit and an interface, for example, for accessing the Internet. The computer or processor may include a microprocessor. The microprocessor may be connected to a communication bus. The computer or processor or FPGA may also include a memory. The memory may include Random Access Memory (RAM) and Read Only Memory (ROM). The computer or processor or FPGA further may include a storage device, which may be a hard disk drive or a removable storage drive such as an optical disk drive, and the like. The storage device may also be other similar means for loading computer programs or other instructions into the computer or processor.

The block diagrams of embodiments herein illustrate various blocks labeled “circuit” or “module.” It is to be understood that the circuits or modules may be implemented as hardware with associated instructions (e.g., software stored on a tangible and non-transitory computer readable storage medium, such as a computer hard drive, ROM, RAM, or the like) that perform the operations described herein. The hardware may include state machine circuitry hard wired to perform the functions described herein. Optionally, the hardware may include electronic circuits that include and/or are connected to one or more logic-based devices, such as microprocessors, processors, controllers, or the like. Optionally, the modules may represent processing circuitry such as one or more FPGAs, application specific integrated circuit (ASIC), or microprocessor. The circuit modules in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, paragraph (f), unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A hovercraft power system, the system comprising:
a ground power supply coupled with at least one on-board DC-DC power converter, the on-board DC-DC power converter positioned on-board a hovercraft;
a power cord tethered to the hovercraft, wherein the power cord is capable of delivering at least 100 kilowatts (kW) of power from the ground power supply to the hovercraft; and
a tether dispenser configured to dispense or retract the power cord tethered to the hovercraft.

2. The hovercraft power system of claim 1, wherein the ground power supply comprises a hydrogen fuel cell.

3. The hovercraft power system of claim 1, wherein the ground power supply comprises a diesel engine.

4. The hovercraft power system of claim 1, further comprising a heat sink coupled adjacent to the at least one on-board DC-DC power converter.

5. The hovercraft power system of claim 4, wherein the heat sink does not comprise a heat pipe.

6. The hovercraft power system of claim 1, wherein the at least one on-board DC-DC power converter in mounted such that airflow from one or more propellers of the hovercraft cools the at least one on-board DC-DC power converter.

7. The hovercraft power system of claim 1, wherein the tether dispenser comprises a reel that dispenses and retracts the power cord at a preselected tension.

8. The hovercraft power system of claim 1, wherein at least one on-board DC-DC power converter comprises one or more sine amplitude converters.

9. The hovercraft power system of claim 1, further comprising a power selection circuit and back-up battery source both on-board the hovercraft, wherein the power selection circuit is configured to switch between power from the power cord and power from the back-up battery source.

10. The hovercraft power system of claim 1, wherein the hovercraft comprises a quad-copter that, when powered by the power cord, has a load of 20-100 pounds or more supported in-flight by the hovercraft.

11. The hovercraft power system of claim 1, wherein the on-board DC-DC power converter is configured to convert 1000 VDC to about 48 VDC with an efficiency of 98%.

12. A hovercraft comprising:
at least one propeller; and
at least one on-board DC-DC power converter configured to be coupled to a tethered power cord supplying power from a ground power supply to power the at least one propeller while the hovercraft is in flight and supporting a 20-100 pound or more payload.

13. The hovercraft of claim 12, wherein the ground power supply comprises a hydrogen fuel cell.

14. The hovercraft of claim 12, wherein the ground power supply comprises a diesel engine.

15. The hovercraft of claim 12, wherein the at least one on-board DC-DC power converter in mounted such that airflow from the at least one propeller cools the at least one on-board DC-DC power converter.

16. The hovercraft of claim 12, wherein at least one on-board DC-DC power converter comprises one or more sine amplitude converters.

17. The hovercraft of claim 12, further comprising a power selection circuit and back-up battery source, wherein the power selection circuit is configured to switch between power from the power cord and power from the back-up battery source.

18. The hovercraft of claim 12, wherein the on-board DC-DC power converter is configured to convert 1000 VDC to about 48 VDC with an efficiency of 98%.

19. A method for powering a hovercraft, the method comprising:
mounting a power converter to the hovercraft;
coupling the hovercraft to a tethered power supply; and
powering the hovercraft while in flight with the tethered power supply such that a 20-100 pound or more payload is supported by the in-flight hovercraft.

20. The method of claim 19, further comprising mounting the power converter to the hovercraft such that airflow from a propeller of the hovercraft cools the power converter.
